(19) United States
(12) Patent Application Publication
(10) Pub. No.: US 2008/0257525 A1
(43) Pub. Date: Oct. 23, 2008

(54) THERMAL CONTROL APPARATUS

(75) Inventors: Akira Ohnishi, Kanagawa (JP); Hosei Nagano, Kanagawa (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Japan Aerospace Exploration Agency, Tokyo (JP)

(21) Appl. No.: 11/777,223

(22) Filed: Jul. 12, 2007

(30) Foreign Application Priority Data
Apr. 20, 2007 (JP) JP 2007-111144

(51) Int. Cl. B60H 1/00

(52) U.S. Cl. 165/41; 165/86

(57) ABSTRACT

Disclosed is a thermal control apparatus which comprises a base plate associated with a target object in a heat-exchangeable manner therebetween, at least one heat-exchange paddle attached to the base plate in such a manner as to be selectively deployed and retracted, paddle drive means provided at an end of the base plate and adapted to drive a deployment movement and a retraction movement of the heat-exchange paddle so as to change an angle of the heat-exchange paddle, and a heat transport element provided to connect the base plate and the heat-exchange paddle.

### CROSS-REFERENCE TO RELATED APPLICATIONS

The present patent application claims priority from Japanese Patent Application No. 2007-111144, filed on Apr. 20, 2007.

### BACKGROUND OF THE INVENTION

1. Field of the Invention

The present invention relates to a thermal control apparatus suitable for use in cosmic environments or ground environments with large temperature changes, to thermally control a device, such as an on-board device for spacecrafts.

2. Description of the Related Art

In spacecrafts to be exposed to both low-temperature and high-temperature environments, it is necessary to keep an on-board device within an allowable temperature range. Typically, a thermal design for the on-board device is performed in conformity to high temperature environments, and a temperature-keeping control based on heating with a heater is combined therewith in low-temperature environments. However, in spacecrafts to be exposed to large environmental changes, such as moon/planetary probe vehicles, a power consumption of the heater will be unacceptably increased to cause difficulty in realizing thermal design.

A “thermal louver” and a “deployable radiator” have been known as conventional thermal control techniques for spacecrafts. The thermal louver is capable of passively coping with changes in thermal environment, whereas it involves problems, such as incapability of increasing an amount of heat dissipation, structural complexity and heavy weight. The deployable radiator intended to promote heat dissipation is deployable only in a unidirectional manner, and therefore incapable of coping with thermal control in low-temperature environments by itself. Moreover, the deployable radiator is typically used in combination with a heat pipe or a fluid loop serving as a heat transport element for efficiently transporting heat to a paddle, which leads to a heavy and complicated mechanism, and is therefore applicable only to large spacecrafts.

### SUMMARY OF THE INVENTION

In view of the above conventional problems, it is an object of the present invention to provide a novel thermal control apparatus capable of facilitating weight reduction and structural/mechanistic simplification, and desirably usable in spacecraft environments or ground environments with large temperature differences.

In order to achieve this object, the present invention provides a thermal control apparatus which comprises a base plate associated with a target object in a heat-exchangeable manner therebetween, at least one heat-exchange paddle attached to the base plate in such a manner as to be selectively deployed and retracted, paddle drive means provided at an end of the base plate and adapted to drive a deployment movement and a retraction movement of the heat-exchange paddle so as to change an angle of the heat-exchange paddle, and a heat transport element provided to connect the base plate and the heat-exchange paddle. In this thermal control apparatus, the base plate has a first surface on an opposite side relative to the target object, and the heat-exchange paddle has a second surface which is a front surface thereof, and a third surface which is a rear surface thereof. The first, second and third surfaces are ones selected from the group consisting of a heat-dissipating surface, a heat-absorbing surface, a heat-insulating surface and a variable heat-emissivity surface. Further, the paddle drive means is adapted to variably set a deployed angle of the heat-exchange paddle.

Preferably, the paddle drive means is one selected from the group consisting of: a reversible shape memory alloy; a bimetal; a unidirectional or bidirectional paraffin actuator; drive means using a combination of a unidirectional shape memory alloy and a biasing spring; an electrically-driven motor; a spring drive mechanism; and a manual drive mechanism. In this case, the shape memory alloy may be a heat pipe-type shape memory alloy having a heat pipe structure incorporated therein.

Preferably, the heat transport element is a graphite sheet or a carbon fiber fabric.

The heat transport element may comprise a heat pipe or a fluid loop.

The heat-dissipating surface may have one selected from the group consisting of a silver-deposited polyetherimide film, an aluminum-deposited teflon film, an optical solar reflector (OSR), a white-colored paint film, a black-colored paint film and a multilayer thin film.

The heat-absorbing surface may have one selected from the group consisting of a graphite sheet, a selective heat-absorptive coating, a black-colored coating and a multilayer thin film.

The variable heat-emissivity surface may have a perovskite-structured manganese oxide film or a vanadium oxide film. In the case where, the variable heat-emissivity surface has the perovskite-structured manganese oxide film, it may further include a multilayer thin film.

The heat-insulating surface may have one selected from the group consisting of a metal-deposited film, a multilayer heat-insulating material and a foamed heat-insulating material.

The thermal control apparatus can accelerate heat-dissipation, maintain temperature and absorb heat in a selective manner by a single apparatus, to facilitate reduction in weight and energy consumption of a spacecraft. In addition, when the spacecraft lands on the Moon, the thermal control apparatus can dissipate and absorb heat during daylight and maintain temperature at night by a single apparatus. Further, the thermal control apparatus can protect an on-board device from contamination due to flying regoliths on the lunar surface. The deployed angle of the paddle can be changed to adjust a heat-dissipation characteristic and a heat-absorption characteristic. The adjustment of the paddle deployed angle makes it possible to autonomously compensate degradation in the heat-dissipation characteristic.

The thermal control apparatus of the present invention can be used as a lightweight deployable radiator for a small satellite. This makes it possible to provide a simplified deployable radiator while achieving enhanced reliability. Further, a high-temperature-heat transport graphite sheet may be used as the heat transport element to eliminate a need for using liquid so as to avoid the problem about freezing of the liquid at low temperatures.

Based on the above advantages, the thermal control apparatus makes it possible to thermally control an on-board device with enhanced efficiency not only in cosmic environments but also ground environments, such as desert regions and vicinities of the Polar Regions.

These and other objects, features and advantages of the invention will become more apparent upon reading the following detailed description along with the accompanying drawings.

### BRIEF DESCRIPTION OF THE DRAWINGS

FIG. 1 is a sectional view showing a thermal control apparatus 10 according to a first embodiment of the present invention.

FIG. 2 is a schematic diagram showing a thermal control apparatus for a medium or large spacecraft, according to a second embodiment of the present invention, wherein a fluid loop is employed.

FIG. 3 is a schematic diagram showing the thermal control apparatus according to the second embodiment.

FIG. 4 is a schematic diagram showing a thermal control apparatus for a medium or large spacecraft, according to a third embodiment of the present invention, wherein a combination of a fluid loop and a high-temperature-heat transport element is employed.

FIG. 5 is a schematic diagram showing the thermal control apparatus according to the third embodiment.

FIG. 6 is a schematic diagram showing a thermal control apparatus according to a fourth embodiment of the present invention, which is suitable for use in celestial objects, such as the Moon and Mars, and polar environments of the Earth.

FIG. 7 is a schematic diagram showing the thermal control apparatus according to the fourth embodiment.

FIG. 8 is a conceptual diagram showing a radiator for a small satellite, according to a fifth embodiment of the present invention.

FIG. 9 is a conceptual diagram showing the radiator according to the fifth embodiment.

FIG. 10 is a conceptual diagram showing an energy storage system according to a sixth embodiment of the present invention.

FIG. 11 is a conceptual diagram showing the energy storage system according to the sixth embodiment.

FIGS. 12(a) to 12(f) are explanatory diagrams showing various layouts of a high-temperature-heat transport element in a thermal control apparatus according to a seven embodiment of the present invention.

FIG. 13 is a table showing a summary of structural elements/configurations applicable to a thermal control apparatus of the present invention.

FIG. 14 is a table showing a summary of materials/mechanisms applicable to components/elements of a thermal control apparatus of the present invention.

### DESCRIPTION OF THE PREFERRED EMBODIMENTS

With reference to the drawings, various embodiments of the present invention will now be described.

### First Embodiment

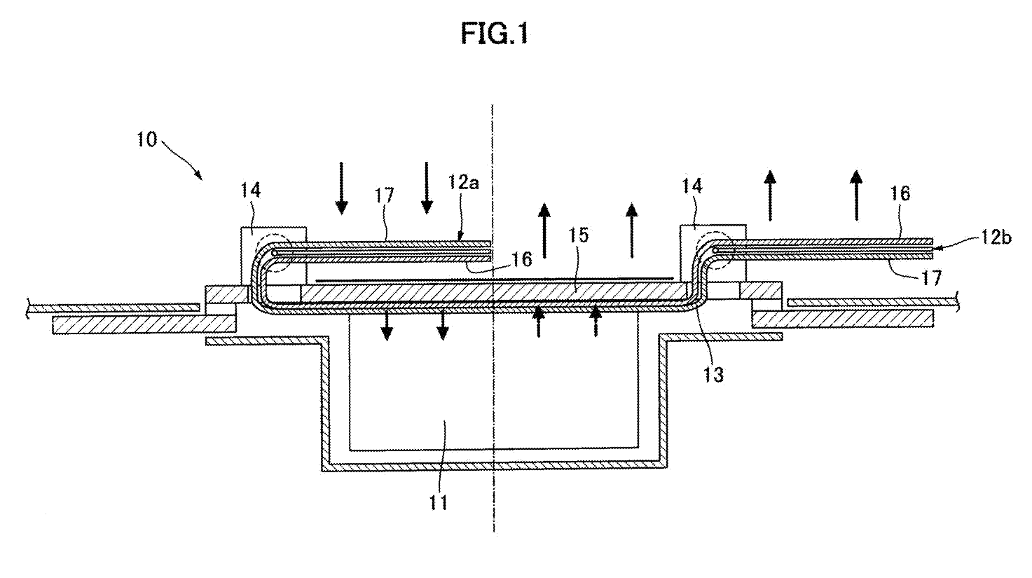

FIG. 1 is a sectional view showing a thermal control apparatus 10 according to a first embodiment of the present invention, wherein a left half thereof shows a state after a paddle of the thermal control apparatus is closed (i.e., retracted), and a right half thereof shows a state after the paddle is opened (i.e., deployed). The thermal control apparatus 10 according to the first embodiment is intended to be installed in a spacecraft, particularly in a small satellite. In FIG. 1, the reference numeral 1 indicates one of various on-board devices of a spacecraft, which are to be subjected to thermal control (hereinafter referred to as “target object”). The thermal control apparatus 10 comprises a base plate 15. In the first embodiment, the base plate 15 is formed as a part of a satellite structure.

As shown in FIG. 1, the thermal control apparatus 10 according to the first embodiment includes a pair of right and left deployable/retractable heat-exchange paddles 12b, 12a (hereinafter referred to as “deployable/retractable heat-exchange paddle 12” or “paddle 12” when they are collectively described). The paddle 12 serves as a means for heat-exchange with an external environment (in this embodiment, cosmic space). The paddle 12 has a front surface 16 which faces outwardly (i.e., faces the external environment) when deployed, and faces inwardly (i.e., faces the spacecraft or the on-board device), and a rear surface 17 on an opposite side of the front surface 16.

The rear surface 17 of the paddle 12 may be one selected from the group consisting of a heat-dissipating surface, a heat-absorbing surface, a heat-insulating surface and a variable heat-emissivity surface. As used in this specification, the term “heat-dissipating surface” means one of the front and rear surfaces 16, 17 which has a heat-emissivity greater than the other surface (wherein the one surface may have a solar absorptance less than that of the other surface or may have a solar absorptance equal to or greater than that of the other surface). The term “heat-absorbing surface” means one of the front and rear surfaces 16, 17 which has a solar absorptance greater than the other surface (wherein the one surface may have a heat-emissivity less than that of the other surface or may have a heat-emissivity equal to or greater than that of the other surface). The term “heat-insulating surface” means a surface having a low heat-emissivity (heat conductivity) so as to prevent solar energy from being transferred (conducted) inside the paddle to suppress heat-exchange with the external environment. The term “variable heat-emissivity surface” means a surface which suppresses heat-dissipation at low temperatures and accelerates heat-dissipation at high temperatures, i.e., which exhibits a relatively low heat-emissivity at low temperatures and exhibits a relatively high emissivity at high temperatures.

The thermal control apparatus 10 includes a heat transport element 13 serving as a means to transport heat. In the first embodiment, a high-temperature-heat transport graphite sheet is used as a material of the heat transport element 13. The graphite sheet is desirable as a material of the heat transport element 13 because it has both high heat conductivity and flexibility. Alternatively, a high-temperature heat-conducting fluid may be used as the heat transport element 13. In this case, the heat transport element 13 may be designed such that this fluid flows through a loop-shaped flexible hose pipe.

The thermal control apparatus 10 includes a deploying/retracting mechanism 14 serving as a means to selectively deploy and retract the paddle 12. The deploying/retracting mechanism 14 may be selected from a passive type or an active type. As the active type, one of a shape-memory alloy, a bimetal, a paraffin actuator, and a shape memory alloy having a heat pipe structure incorporated therein may be used to utilize a temperature-dependent change in spring force thereof (this mechanism may also be used in each of after-mentioned embodiments). As the active type, an electrically-heatable shape-memory alloy or an electrically-driven motor may be used. The target object 11 is connected to the deploying/retracting mechanism 14 directly or indirectly. That is, the deploying/retracting mechanism 14 is designed such that a temperature thereof is changed in conjunction with a change in temperature of the target object.

The front and rear surfaces 16, 17 of the paddle 12 can be formed of ones selected from the aforementioned surfaces to perform a specific thermal control depending on an intended purpose. For example, if one of the surfaces which is to be exposed to the external environment when the paddle 12 is closed (i.e., retracted) (in the first embodiment, the rear surface 17) is formed as the heat-dissipating surface, the surface will function to accelerate heat-dissipation when the paddle 12 is retracted, so that the temperature of the target object 11 can be lowered. If the surface to be exposed to the external environment when the paddle 12 is retracted is formed as the heat-absorbing surface, it will function to suppress heat-dissipation and absorb solar light when the paddle 12 is retracted, so that the temperature of the target object 11 can be increased. If the surface to be exposed to the external environment when the paddle 12 is retracted is formed as the heat-insulating surface, it will function to suppress heat-exchange with the external environment when the paddle 12 is retracted, so that the temperature of the target object 11 can be maintained at a value when the paddle 12 is closed. If the surface to be exposed to the external environment when the paddle 12 is retracted is formed as the variable heat-emissivity surface, it will function to suppress heat-dissipation when the paddle 12 is retracted (at low temperatures), and to accelerate heat-dissipation when the paddle 12 is deployed (at high temperatures).

In the first embodiment, the deploying/retracting mechanism 14 is designed to move the paddle 12 between a fully deployed position (full open position) and a fully retracted position (full closed position). In addition, the deploying/retracting mechanism 14 is designed to variably set the fully deployed position at any angle. Based on this function of changing the angle of the fully deployed position of the paddle 12, an amount of heat-exchange can be adjusted to further adequately control the temperature of the target object 11.

The thermal control apparatus 10 according to the first embodiment can be installed in a spacecraft, such as a satellite, to obtain the following advantages. As one advantage, the thermal control apparatus 10 can accelerate heat-dissipation, maintain temperature and absorb heat by a single apparatus, to facilitate reduction in weight and energy consumption of the spacecraft. As another advantage, when the spacecraft lands on the Moon or Mars, the thermal control apparatus can dissipate and absorb heat during daylight and maintain temperature at night by a single apparatus. As yet another advantage, the thermal control apparatus can protect the heat-dissipating surface and the on-board device from contamination due to flying regoliths on the lunar surface. As still another advantage, the deployed angle of the paddle can be changed to adjust a heat-dissipation characteristic and a heat-absorption characteristic so as to autonomously compensate degradation in the heat-dissipation characteristic according to the adjustment of the deployed angle of the paddle.

The thermal control apparatus 10 according to the first embodiment can be used as a lightweight deployable radiator for a small satellite. This makes it possible to provide a simplified deployable radiator while achieving enhanced reliability. Further, a high-temperature-heat transport graphite sheet may be used as the heat transport element 13 to eliminate a need for using liquid so as to avoid a problem about freezing of the liquid at low temperatures.

Based on the above advantages, the thermal control apparatus 10 makes it possible to thermally control an on-board device with enhanced efficiency not only in cosmic environments but also ground environments, such as desert regions and vicinities of the Polar Regions.

### Second Embodiment

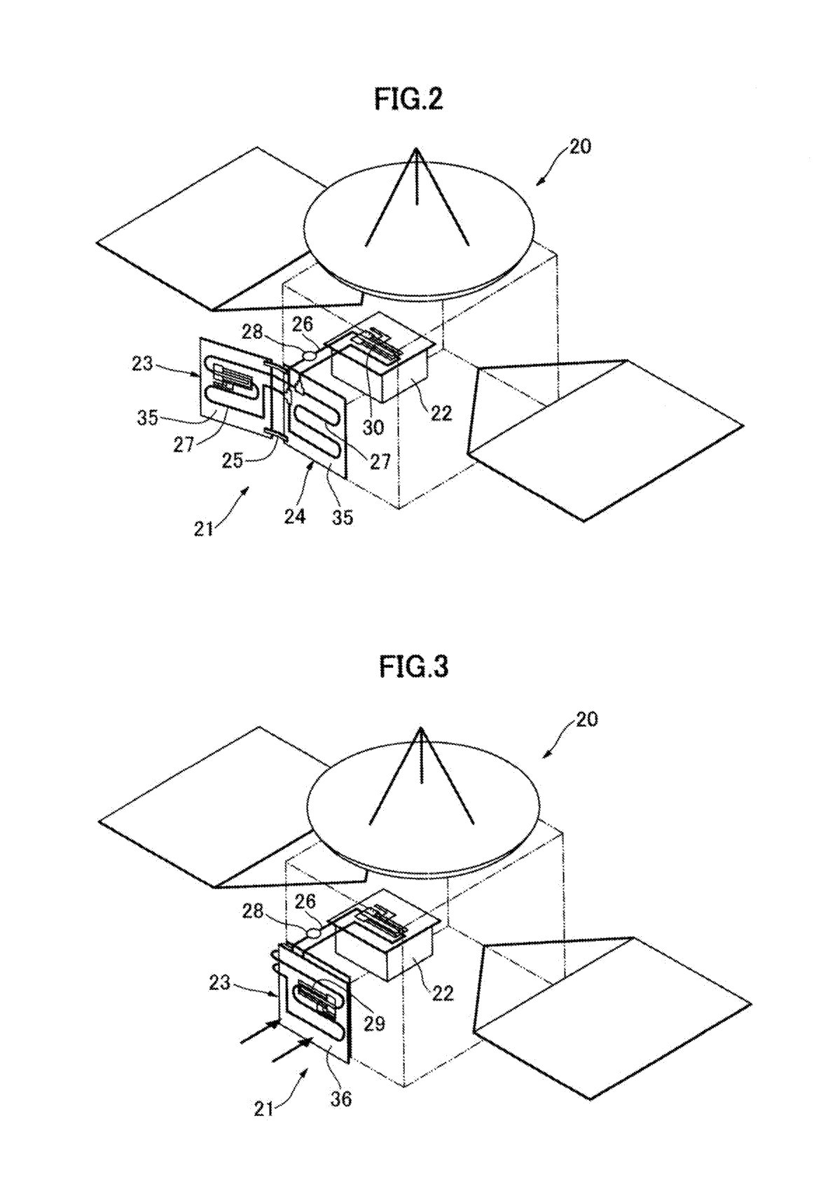

As a second embodiment of the present invention, a thermal control apparatus 21 for a medium or large spacecraft, which employs a fluid loop, will be described with reference to FIGS. 2 and 3. FIGS. 2 and 3 show a medium or large spacecraft 20 equipped with the thermal control apparatus 21 according to the second embodiment, wherein a heat-exchange paddle 23 of the thermal control apparatus 21 illustrated in FIG. 2 is set in its opened (i.e., deployed) position, and the heat-exchange paddle 23 illustrated in FIG. 3 is set in its closed (i.e., retracted) position.

The thermal control apparatus 21 comprises a heat-receiving member 22 which encloses or covers an on-board device generating heat, the heat-exchange paddle 23, a base plate 24, a deploying/retracting mechanism 25 and a fluid loop 26. The heat-exchange paddle 23 and the base plate 24 have a pipe 27 attached onto respective surfaces thereof to extend all over the surfaces while allowing fluid to flow therethrough. The fluid loop 26 connects a pipe attached on a top wall of the heat-receiving member 22 and the pipe on the heat-exchange paddle 23 and the base plate 24, in a closed-loop manner. The thermal control apparatus 21 further includes a mechanical pump 28 for driving circulation of the fluid, and two evaporating elements 29, 30 are provided on the top wall of the heat-receiving member 22 and a rear surface of the heat-exchange paddle 23 to generate a capillary force within the fluid loop 26. A heat-dissipating material 35 is attached onto each of a front surface of the heat-exchange paddle 23 and a front surface of the base plate 24, and a heat-absorbing material 36 is attached onto the rear surface of the heat-exchange paddle 23.

In the second embodiment, when the heat-receiving member 22 (i.e., on-board device) in the spacecraft has a relatively high temperature, the deploying/retracting mechanism 25 is operable to deploy the heat-exchange paddle 23 so as to swingably move the heat-exchange paddle 23 to the opened (i.e., deployed) position as illustrated in FIG. 2. Thus, heat is dissipated from the front and rear surfaces of the heat-exchange paddle 23 and the front surface of the base plate 24. When the temperature of the heat-receiving member 22 in the spacecraft is less than a predetermined value, the deploying/retracting mechanism 25 is operable to retract the heat-exchange paddle 23 so as to swingably move the heat-exchange paddle 23 to the closed (i.e., retracted) position as illustrated in FIG. 3.

Thus, the base plate 24 is fully covered by the front surface of the heat-exchange paddle 23, and only the rear surface of the heat-exchange paddle 23 is exposed to cosmic space so as to suppress heat-dissipation at a minimum level.

When a temperature of the rear surface of the heat-exchange paddle 23 becomes greater than that of the inside of the spacecraft due to solar light, the mechanical pump 28 or the evaporating elements 29 incorporated in the heat-exchange paddle 23 and the heat-receiving member 22 are activated to transport solar heat energy to the heat-receiving member 22 so as to increase the temperature of the on-board device.

### Third Embodiment

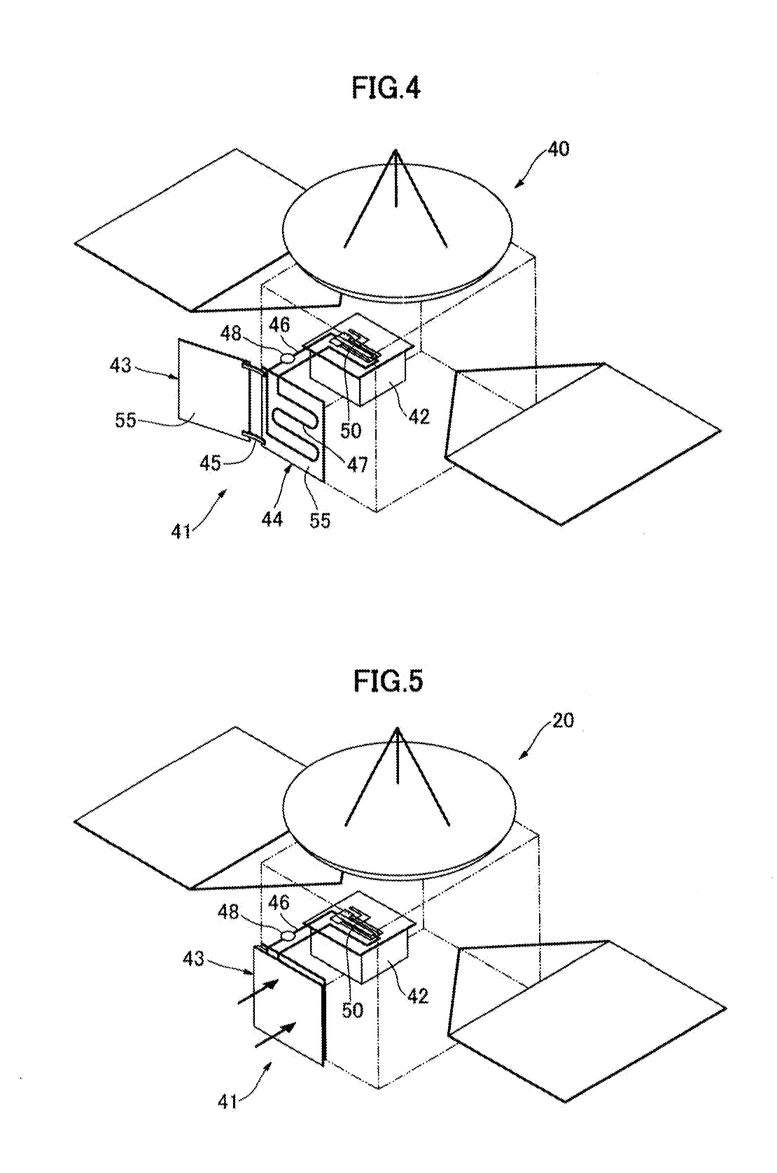

As a third embodiment of the present invention, a thermal control apparatus 41 for a medium or large spacecraft, which employs a combination of a fluid loop and a high-temperature-heat transport element, will be described with reference to FIGS. 4 and 5. FIGS. 4 and 5 show a medium or large spacecraft 40 equipped with the thermal control apparatus 41 according to the third embodiment, wherein a heat-exchange paddle 43 of the thermal control apparatus 41 illustrated in FIG. 4 is set in its opened (i.e., deployed) position, and the heat-exchange paddle 43 illustrated in FIG. 5 is set in its closed (i.e., retracted) position.

The thermal control apparatus 41 comprises a heat-receiving member 42 which encloses or covers an on-board device generating heat, the heat-exchange paddle 43, a base plate 44, a deploying/retracting mechanism 45 and a fluid loop 46. The base plate 44 has a pipe 47 attached onto a surface thereof to extend all over the surface while allowing fluid to flow therethrough. The fluid loop 46 connects a pipe attached on a top wall of the heat-receiving member 42 and the pipe on the base plate 44, in a closed-loop manner. The thermal control apparatus 41 further includes a mechanical pump 48 for driving circulation of the fluid, and two parallel heating elements 50 are provided on the top wall of the heat-receiving member 42 to generate a capillary force within the fluid loop 46. A heat-dissipating material 55 is attached onto each of a front surface of the heat-exchange paddle 43 and a front surface of the base plate 44, and any one of a heat-absorbing material, a temperature-keeping material and a heat-insulating material 36 is attached onto a rear surface of the heat-exchange paddle 23.

In the third embodiment, when the heat-receiving member 42 in the spacecraft has a relatively high temperature, the deploying/retracting mechanism 45 is operable to deploy the heat-exchange paddle 43 so as to swingably move the heat-exchange paddle 43 to the opened (i.e., deployed) position as illustrated in FIG. 4. Thus, heat is dissipated from the front and rear surfaces of the heat-exchange paddle 43 and the front surface of the base plate 44.

When the temperature of the heat-receiving member 42 in the spacecraft is less than a predetermined value, the deploying/retracting mechanism 45 is operable to retract the heat-exchange paddle 43 so as to swingably move the heat-exchange paddle 43 to the closed (i.e., retracted) position as illustrated in FIG. 5. Thus, the base plate 44 is fully covered by the front surface of the heat-exchange paddle 43, and only the rear surface of the heat-exchange paddle 43 is exposed to cosmic space. This makes it possible to suppress heat-dissipation at a minimum level while preventing freezing of the fluid (liquid phase). In the case where the heat-absorbing material is attached onto the rear surface of the heat-exchange paddle 43, it will absorb heat of solar light incident thereon to warm the base plate 44 based on heat conduction and radiation.

### Fourth Embodiment

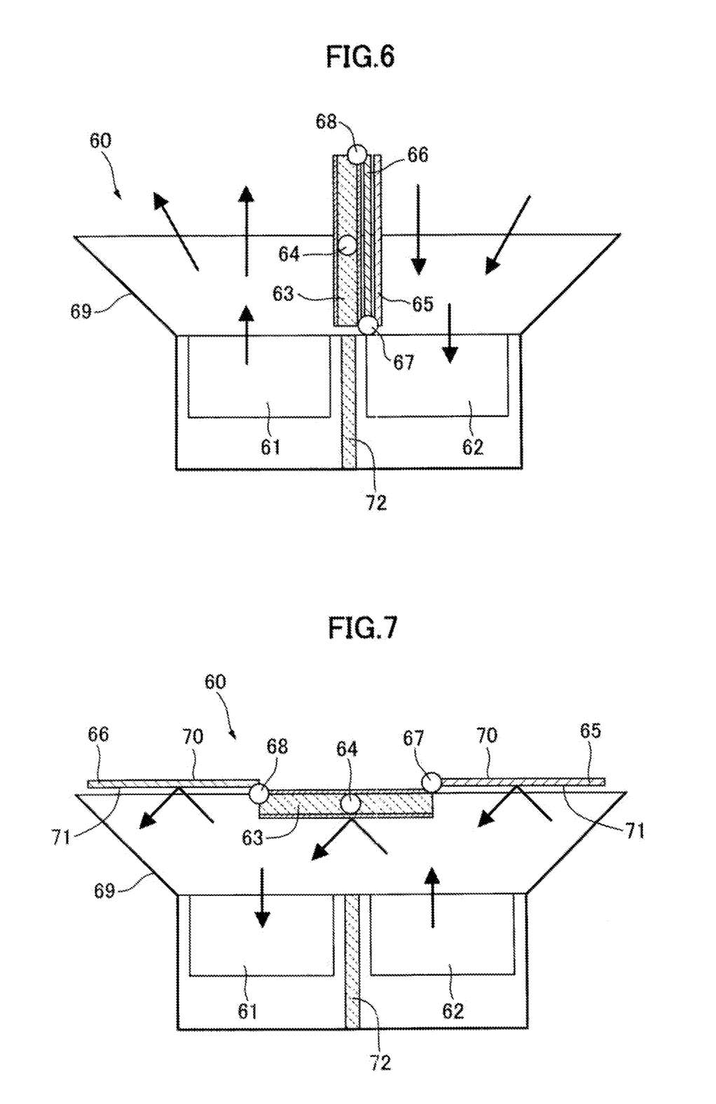

As a fourth embodiment of the present invention, a thermal control apparatus 60 suitable for use in celestial objects, such as the Moon and Mars, and polar environments of the Earth, will be described with reference to FIGS. 6 and 7. FIGS. 6 and 7 show the thermal control apparatus 60 according to the fourth embodiment, wherein a paddle unit of the thermal control apparatus 60 illustrated in FIG. 6 is set in its closed (i.e., retracted) position, and the paddle unit illustrated in FIG. 7 is set in its opened (i.e., deployed) position.

The thermal control apparatus 60 according to the fourth embodiment is designed to thermally control the on-board device 61 in celestial objects, such as the Moon and Mars, and polar environments of the Earth. The thermal control apparatus 60 comprises a heat storage material 64 having a heat storing (i.e., accumulating) function, a rotatable paddle 63, an actuator 64 for controlling a rotational movement of the rotatable paddle 63, two deployable/retractable paddles 65, 66 swingably connected to respective opposite ends of the rotatable paddle 63, and two actuators 67, 68 for controlling respective swing movements of the deployable/retractable paddles 65, 66 between their deployed positions and retracted positions. Each of the rotatable paddle 63 and the deployable/retractable paddles 65, 66 has a front surface 70 having a low heat-emissivity material or a heat-insulating material attached thereon, and a rear surface 71 having a heat-reflecting material (i.e., material with a function of reflecting heat) attached thereon. The thermal control apparatus 60 further includes a heat-insulating member 72 disposed between the on-board device 61 and the heat storage material 62.

As shown in FIG. 6, the actuator 64 is operable, during daytime, i.e., when the on-board device has a relatively high temperature, to rotatably move the rotatable paddle 63 to an approximately vertical position, and simultaneously the actuators 67, 68 are operable to swingably move the respective deployable/retractable paddles 65, 66 to their retracted positions. The rotatable paddle 63 has a heat-insulating function. Thus, the heat-insulating member 72 and the rotatable paddle 63 preclude heat-exchange between the on-board device 61 and the heat storage material 62, so that heat of the on-board device 62 can be dissipated while allowing the heat storage material to absorb solar heat.

At night i.e., when the on-board device has a relatively low temperature, the actuator 64 is operable to rotatably move the rotatable paddle 63 to an approximately horizontal position, and simultaneously the actuators 67, 68 are operable to swingably move the respective deployable/retractable paddles 65, 66 to their approximately horizontal deployed positions, so as to close a shade 69 to block heat-exchange with an external environment, as shown in FIG. 7. Further, the heat-insulating member 72 between the on-board device 61 and the heat storage material 62 is removed to supply radiation heat from the heat storage material 62 to the on-board device 61 which will otherwise be cooled to an excessively low temperature, so as to keep the on-board device 61 at an adequate temperature.

### Fifth Embodiment

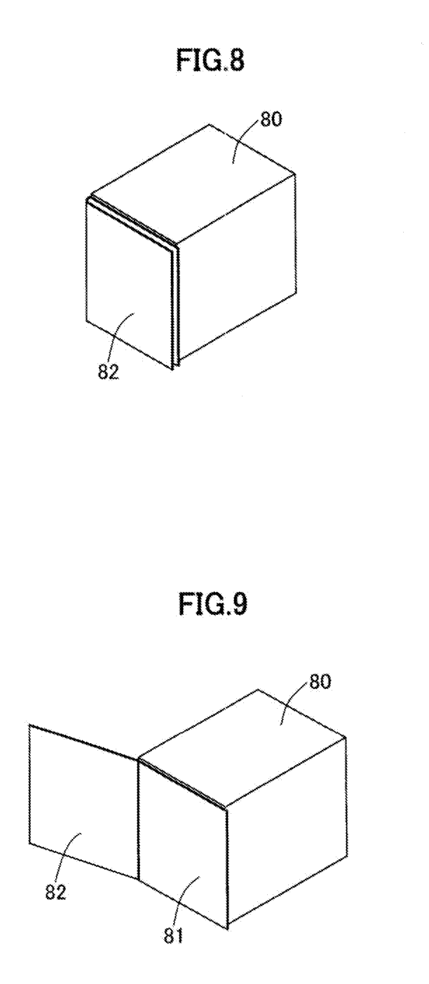

FIGS. 8 and 9 are conceptual diagrams showing a radiator for a small satellite, according to a fifth embodiment of the present invention. In FIGS. 8 and 9, the reference numeral 80 indicates a small spacecraft to be subjected to thermal control. A heat-dissipating paddle 82 is attached to a structure of the small spacecraft 80 in a deployable manner. A high emissivity material is attached onto each of a surface 81 of the spacecraft structure and front and rear surfaces of the heat-dissipating paddle 82. The heat-dissipating paddle 82 is composed of a high-temperature-heat transport element.

During a launch of the satellite 80, the heat-dissipating paddle 82 is closed, i.e., retracted, as shown in FIG. 8. Then, at a certain timing after the satellite 80 is placed in an orbit, the heat-dissipating paddle 82 is unidirectionally deployed, as shown in FIG. 9.

The term “unidirectionally” means that, if the heat-dissipating paddle 82 is deployed once, it is permanently kept in its deployed position without being retracted. This can eliminate the need for providing a mechanism for retracting the heat-dissipating paddle 82, so as to allow the thermal control device to be structurally simplified while reducing the risk of malfunction.

In response to deploying the heat-dissipating paddle 82, internal heat of the small satellite is transported to the hear-dissipating paddle 82 through the high-temperature-heat transport element to accelerate heat-dissipation. This makes it possible to provide an efficient deployable radiator with a simplified structure.

### Sixth Embodiment

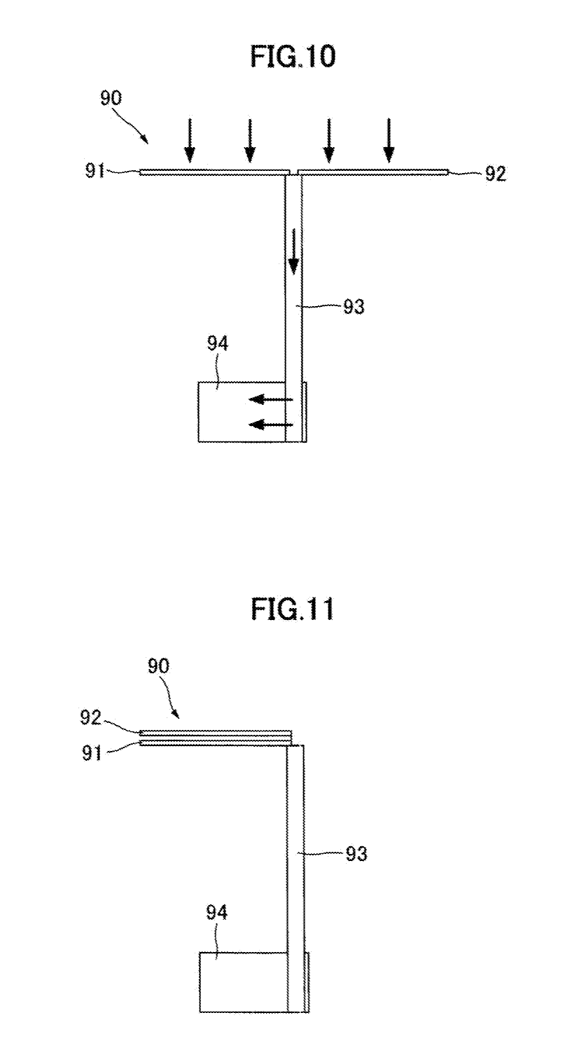

FIGS. 10 and 11 are conceptual diagrams showing an energy storage system according to a sixth embodiment of the present invention. The energy storage system 90 according to the sixth embodiment comprised a wall 91 which has a front surface formed as a heat-absorbing surface and a rear surface formed as a heat-insulating surface, a deployable/storable heat-exchange paddle 92 which has a front surface formed as a heat-absorbing surface and a rear surface formed as a heat-insulating surface, a high-temperature-heat transport element 93 for transporting heat, and an energy storage unit 94 for storing heat transported by the high-temperature-heat transport element 93. Each of the heat-absorbing surfaces of the wall 91 and the heat-exchange paddle 92 are connected to the high-temperature-heat transport element 93.

During daytime with solar light, the heat-exchange paddle 92 is deployed as shown in FIG. 10. In this deployed position, the respective front heat-absorbing surfaces of the wall 91 and the heat-exchange paddle 92 are irradiated with solar light to absorb heat of the solar light. This heat is transported to the inside of the system through the high-temperature-heat transport element 93 connected to these heat-absorbing surfaces, and stored in the energy storage unit 94. During this process, the rear heat-insulating surfaces of the wall 91 and the heat-exchange paddle 92 make it possible to efficiently store energy while preventing dissipation of the heat stored in the energy storage unit 94.

At night with a relatively low temperature due to there being no solar light, the heat-exchange paddle 92 is retracted as shown in FIG. 11, and the heat-absorbing surfaces of the wall 91 and the heat-exchange paddle 92 come into contact with each other in opposed relation. Thus, the wall 91 and the heat-exchange paddle 92 are disposed as if they are a single plate which has opposite sides each formed of a heat-insulating surface, to suppress dissipation of the heat stored in the energy storage unit 94 at a minimum level.

### Seventh Embodiment

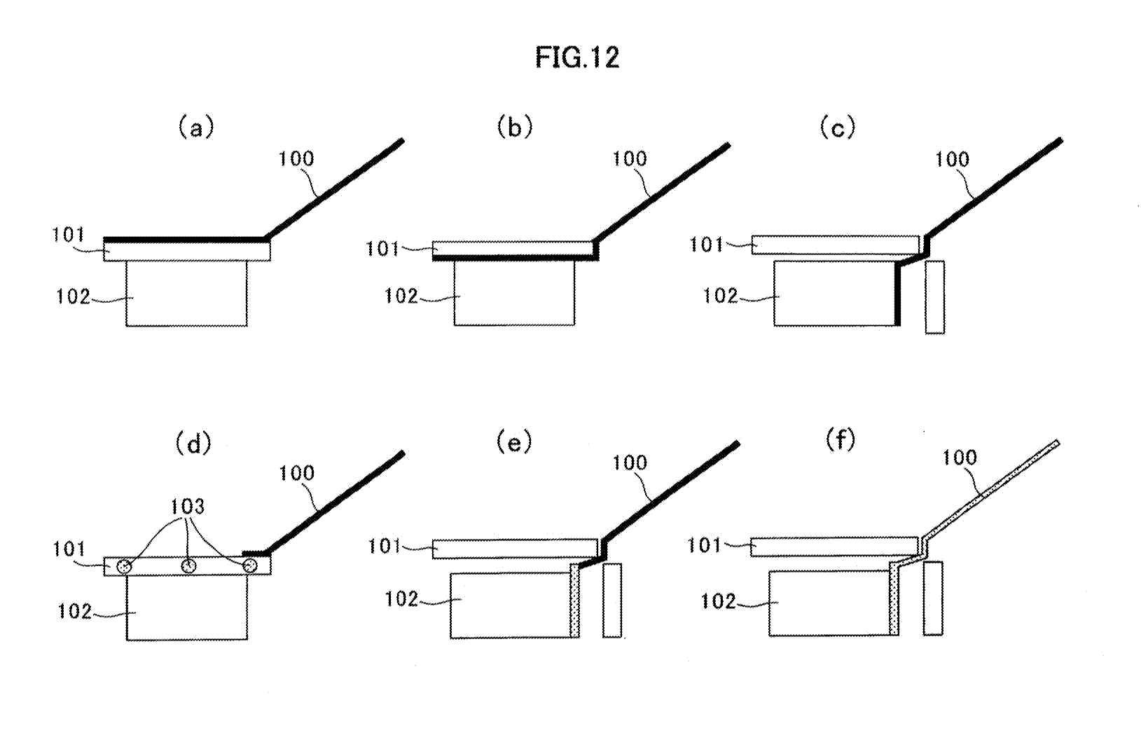

With reference to FIGS. 12(a) to 12(f), various layouts of a high-temperature-heat transport element in a thermal control apparatus according to a seven embodiment of the present invention will be described below. In FIGS. 12(a) to 12(f), a first high-temperature-heat transport element 100 indicated by a thick block line is actually connected between the paddle and the component located closer to the spacecraft, in each of the deployable/retractable thermal control apparatuses according to the first embodiment (FIG. 1), the second embodiment (FIGS. 2 and 3), the third embodiment (FIGS. 4 and 5), and the fifth embodiment (FIGS. 8 and 9). In FIGS. 12(a) to 12(f), the reference numeral 101 indicates a base plate as the component located closer to the spacecraft, and the reference numeral 102 indicates one of various on-board devices to be subjected to thermal control (i.e., target object). The reference numeral 103 indicates a second high-temperature-heat transport element incorporated in the base plate.

FIG. 12(a) shows one example where the first high-temperature-heat transport element 100 is attached onto a top surface of the base plate 101, and FIG. 12(b) shows another example where the first high-temperature-heat transport element 100 is attached onto a bottom surface of the base plate 101. FIG. 12(c) shows yet another example where the first high-temperature-heat transport element 100 is directly attached onto the target object 102, and FIG. 12(d) shows still another example where the first high-temperature-heat transport element 100 is attached onto only an end region of the top surface of the base plate 101 incorporating the second high-temperature-heat transport element, such as a heat pipe or a fluid loop. FIGS. 12(e) and 12(f) show other examples where a third high-temperature-heat transport element, such as a heat pipe or a fluid loop, is directly attached onto the target object 102, wherein the third high-temperature-heat transport element in FIG. 12(e) is composed of the first high-temperature-heat transport element 100 and the second high-temperature-heat transport element attached to the target object 102, and the third high-temperature-heat transport element in FIG. 12(f) consists only of the second high-temperature-heat transport element, such as a fluid loop. In FIG. 12(e), heat is transported in the following order: the on-board device→the second heat transport element, such as a fluid loop→the heat transport element, such as a high conductivity material→cosmic space. In FIG. 12(f), heat is transported in the following order: the on-board device→the second heat transport element, such as a fluid loop→cosmic space.

As an example, structural elements/configurations and materials/mechanisms applicable to a thermal control apparatus of the present invention will be described below.

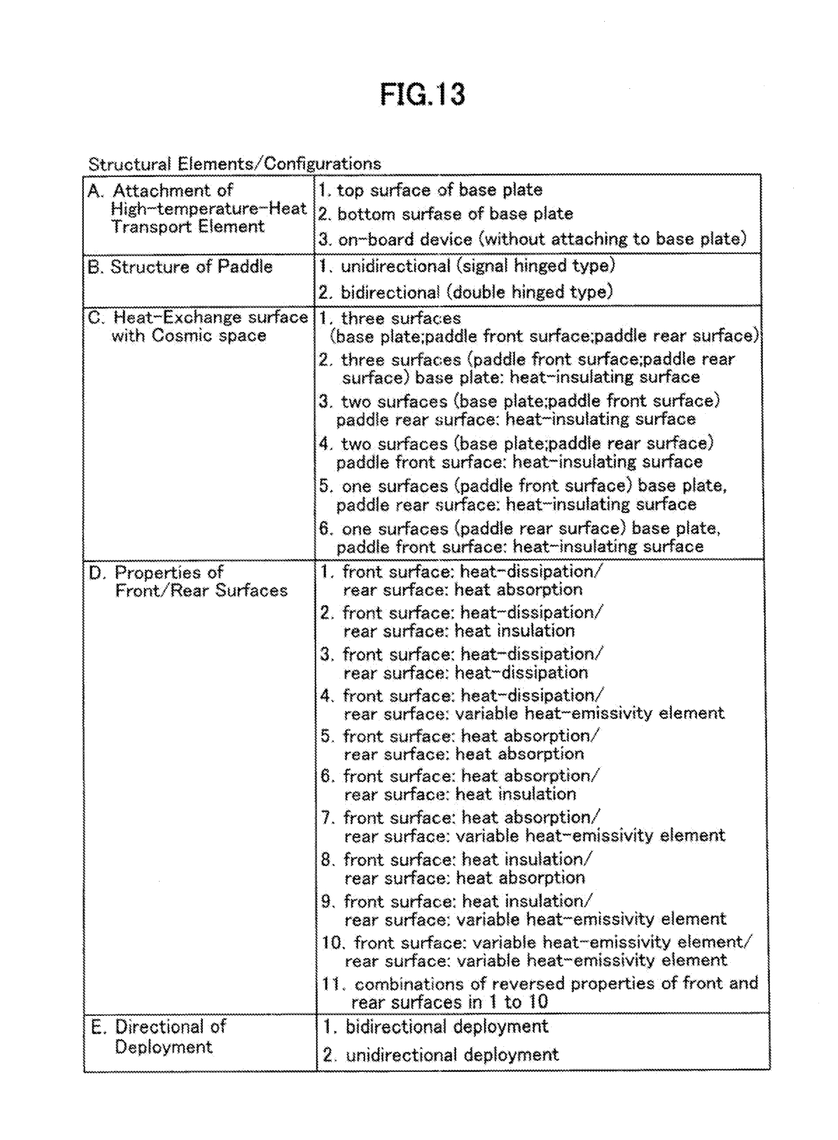

FIG. 13 is a table showing a summary of the applicable structural elements/configurations. In FIG. 13, the section “A. Attachment of High-Temperature-Heat Transport Element” shows options about an attachment position of a high-temperature-heat transport element for transporting heat to a paddle, which includes: attaching it onto a top surface of a base plate; attaching it onto a bottom surface of the base plate, and directly attaching it to an on-board device. The section “B. Structure of Paddle” shows options which included one type where a single paddle is attached to one end of the base plate; and another type where two paddles are attached to respective opposite ends of the base plate. The section “C. Heat-Exchange Surface with Cosmic Space” shows options about the number of surfaces for use in heat-exchange with cosmic space. In this section, the “paddle front surface” means a surface of the paddle to be located on the same side as that of the base plate in its deployed position (i.e., a surface of the paddle to be located in opposed relation to that of the base plate in its retracted position). In the type having two paddles (double hinged type), the number of heat-exchange surfaces may be set in the range of two to five.

The section “D. Properties of Front/Rear Surfaces” shows options about how to select each property of front and rear surfaces of the paddle from a heat-dissipating surface, a heat-absorbing surface, a heat-insulating surface and a variable heat-emissivity surface. As mentioned above, the term “heat-dissipating surface” means one of the front and rear surfaces which has a heat-emissivity greater than the other surface (regardless of a solar absorptance of one surface relative to that of the other surface), and the term “heat-absorbing surface” means one of the front and rear surfaces which has a solar absorptance greater than the other surface (regardless of a heat-emissivity of the one surface relative to that of the other surface). Further, the term “heat-insulating surface” means a surface having a low heat-emissivity (low heat conductivity) and a low solar heat absorptance, and the term “variable heat-emissivity surface” means a surface which exhibits a relatively low heat-emissivity at low temperatures and exhibits a relatively high emissivity at high temperatures.

The section “E. Direction of Deployment” shows options which includes one type where the paddle is bidirectionally deployable (can be reversibly deployed and retracted), and another type where the paddle is unidirectionally deployable (can be only deployed)

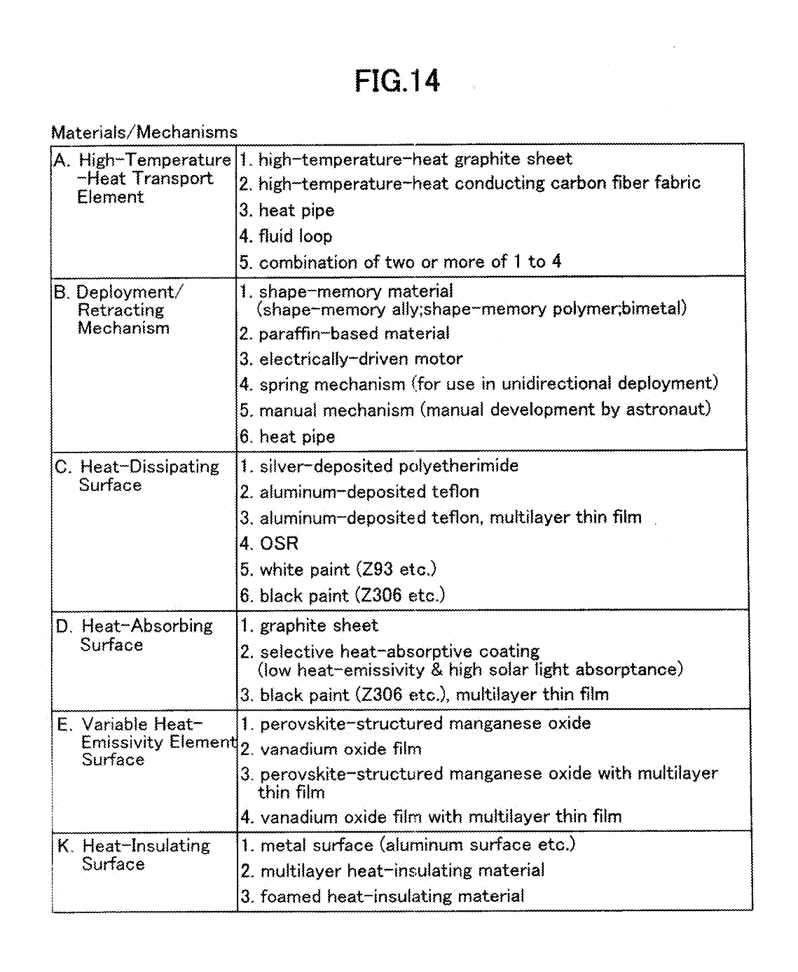

FIG. 14 is a table showing a summary of materials/mechanisms applicable to components/elements of the thermal control apparatus. These materials/mechanisms are particularly preferable although materials/mechanisms for the components/elements are not limited to those in the table of FIG. 14.

Advantageous embodiments of the invention have been shown and described. It is obvious to those skilled in the art that various changes and modifications may be made therein without departing from the spirit and scope thereof as set forth in appended claims.

What is claimed:

1. A thermal control apparatus, comprising:
a base plate associated with a target object in a heat-exchangeable manner therebetween;
at least one heat-exchange paddle attached to said base plate in such a manner as to be selectively deployed and retracted;
paddle drive means provided at an end of said base plate and adapted to drive a deployment movement and a retraction movement of said heat-exchange paddle so as to change an angle of said heat-exchange paddle; and
a heat transport element provided to connect said base plate and said heat-exchange paddle,
wherein:
said base plate has a first surface on an opposite side relative to said target object, and said heat-exchange paddle has a second surface which is a front surface thereof, and a third surface which is a rear surface thereof, wherein said first, second and third surfaces are ones selected from the group consisting of a heat-dissipating surface, a heat-absorbing surface, a heat-insulating surface and a variable heat-emissivity surface; and
said paddle drive means is adapted to variably set a deployed angle of said heat-exchange paddle.

2. The thermal control apparatus as defined in claim 1, wherein said paddle drive means is one selected from the group consisting of: a reversible shape memory alloy; a bimetal; a unidirectional or bidirectional paraffin actuator; drive means using a combination of a unidirectional shape memory alloy and a biasing spring; an electrically-driven motor; a spring drive mechanism; and a manual drive mechanism.

3. The thermal control apparatus as defined in claim 2, wherein said shape memory alloy has a heat pipe structure incorporated therein.

4. The thermal control apparatus as defined in claim 1, wherein said heat transport element is a graphite sheet or a carbon fiber fabric.

5. The thermal control apparatus as defined in claim 1, wherein said heat transport element comprises a heat pipe or a fluid loop.

6. The thermal control apparatus as define in claim 1, wherein said heat-dissipating surface has one selected from the group consisting of a silver-deposited polyetherimide film, an aluminum-deposited teflon film, an optical solar reflector (OSR), a white-colored paint film, a black-colored paint film and a multilayer thin film.

7. The thermal control apparatus as defined in claim 1, wherein said heat-absorbing surface has one selected from the group consisting of a graphite sheet, a selective heat-absorptive coating, a black-colored coating and a multilayer thin film.

8. The thermal control apparatus as defined in claim 1, wherein said variable heat-emissivity surface has a perovskite-structured manganese oxide film or a vanadium oxide film.

9. The thermal control apparatus as defined in claim 8, wherein said variable heat-emissivity surface with said perovskite-structured manganese oxide film further includes a multilayer thin film.

10. The thermal control apparatus as defined in claim 1, wherein said heat-insulating surface has one selected from the group consisting of a metal-deposited film, a multilayer heat-insulating material and a foamed heat-insulating material.

11. A thermal control apparatus, comprising:
a rotatable paddle disposed above a target object and adapted to be rotationally moved between an approximately vertical position and an approximately horizontal position by about 90 degrees, according to a first rotation actuator;
a first deployable/retractable paddle swingably connected to one end of said rotatable paddle and adapted to be swingingly moved between a deployed position and a retracted position by about 180 degrees, according to a second rotation actuator;
a second deployable/retractable paddle swingably connected to the other end of said rotatable paddle and adapted to be swingingly moved between a deployed position and a retracted position by about 180 degrees, according to a third rotation actuator,
wherein said second and third rotation actuators are operable, when said rotatable paddle is rotationally moved to said approximately vertical position according to said first actuator, to swingably move said first and second deployable/retractable paddles to said respective retracted positions so as to allow said target object to be opened to an external environment, and, when said rotatable paddle is rotationally moved to said approximately horizontal position according to said first actuator, to swingably move said first and second deployable/retractable paddles to said respective deployed positions so as to allow said target object to be closed to the external environment,

12. The thermal control apparatus as defined in claim 11, wherein each of said rotatable paddle and said first and second deployable/retractable paddles has a front surface which faces the external environment when said rotatable paddle is in said approximately vertical position, and a rear surface on an opposite side of said front surface, said rear surface being provided with a heat-reflecting material, said front surface being provided with a heat insulating material or a material having a heat emissivity less than that of said material of said rear surface.

13. The thermal control apparatus as defined in claim 11, which further includes:
a heat storage material below said rotatable paddle in adjacent relation to said target object; and
a heat-insulating member adapted to be installed at a position between said target object and said heat storage material when said rotatable paddle is in said approximately vertical position, and removed from said position between said target object and said heat storage material when said rotatable paddle is in said approximately horizontal position.
